(19) United States
(12) Patent Application Publication
(10) Pub. No.: US 2003/0205182 A1
(43) Pub. Date: Nov. 6, 2003

(54) Brick making and in the manufacture of other types of man-made stone like materials

(76) Inventor: Scotlund Stivers, Superior, WI (US)

Correspondence Address: Scotlund Stivers, P.O. BOX 241, Superior, WI, 54880, US

(21) Appl. No.: 10/409,831

(22) Filed: Apr. 8, 2003

Related U.S. Application Data
(62) Division of application No. 09/911,217, filed on Jul. 23, 2001.
(60) Provisional application No. 60/220,609, filed on Jul. 25, 2000.

(51) Int. Cl. D01F 13/00; B29B 17/00; F23B 7/00

(52) U.S. Cl. 110/341

(57) ABSTRACT

Improvements in the manufacture of brick, sand-lime brick, and other man-made stone-like materials.

### CROSS REFERENCE TO RELATED APPLICATIONS

Part or all of this subject matter was disclosed in U.S. Provisional Patent application serial No. 60/220,609 Filed Jul. 25, 2000, and U.S. Non-Provisional patent application Ser. No. 09/911, 217 and U.S. Non-Provisional patent application Ser. No. 09/911,247, both filed Jul. 23, 2001.

### STATEMENT REGARDING FEDERALLY SPONSORED RESEARCH OR DEVELOPMENT

The invention was NOT made by an agency of the United States Government, NOR was it under contract with an agency of the United States Government.

### BACKGROUND OF THE INVENTION

1. Field of the Invention

This invention relates to the manufacture of bricks, sand-lime brick, and other types of man made stone-like materials.

2. Description of the Invention

The manufacture of brick, sand-lime brick, and other man made stone-like materials is well known in the art, and typically entails the formation of metamorphic minerals to bind the mass together (e.g. sand-lime brick, common brick, etc.), hydration/oxidation of minerals (e.g. Portland cement and concrete), recrystalization of existing minerals (e.g. certain types of fire brick), binders of various sorts (e.g. foundry mold cores made of sand and sodium silicate and or molasses), the formation of glass (e.g. pottery glazing and glass), fusion (e.g. fused alumina), etc. Most processes of which require considerable amounts of heat. The present invention covers the utilization of low grade and/or low cost and/or waste heat to supply part or all of the energy needed, and the utilization of various waste materials and low cost materials such as dredging spoils, excavation wastes, water treatment lime sludge, contaminated soil, waste foundry sand, fly ash, coal ashes and clinkers, spent calcium carbide lime, etc. to manufacture brick, sand-lime bricks, and other man-made stone-like materials, reducing the cost of manufacturing, conserving mineral and energy resources, saving on landfill space, and protecting the environment.

### BRIEF SUMMARY OF THE INVENTION

Briefly, the invention comprises improvements in the manufacturing of brick, sand-lime brick, and other man made stone like materials in the areas of feedstock materials and sources of energy.

### DESCRIPTION OF PREFERRED EMBODIMENT

Utilizing waste heat from say, a power plant in the form of 150 PSIG steam, sand-lime brick protomaterial composed of say, lime from a water treatment plant and from an acetylene manufacturing plant, are mixed with screened dredge spoils, waste foundry sand, fly-ash, and ground/screened coal ash/clinkers is metamorphisized into sand-lime brick in a pressurized chamber for several hours forming interlocking crystals of calcium silicate, etc. which bind the various granules of the other materials together. After cooling and depressurizing, they are removed from the chamber and sold and/or used.

I claim:

1. The use of low value heat, such as waste heat, low grade heat, low cost heat etc., to Supply part or all of the energy needed to manufacture brick, sand-lime brick, and other man-made stone like materials.

2. The use of spent lime, waste lime, waste foundry sand, dredging spoils, excavation waste, contaminated soil, fly-ash, coal ash, coal clinkers, spent sand blasting media, spent grinding grit, quarry dust, street dust, mine dust, mine tailings, taconite tailings, metal winning tailings, well drilling waste, lime sludge and the like as part or all of the raw materials to make brick, sand-lime brick, and other man-made stone-like materials.
